(19) United States
(12) Patent Application Publication
(10) Pub. No.: US 2008/0153000 A1
(43) Pub. Date: Jun. 26, 2008

(54) Lithium storage battery comprising a current-electrode collector assembly with expansion cavities and method for producing same

(75) Inventors: Raphael Salot, Lans en Vercors (FR); Frederic Gaillard, Voiron (FR); Stephane Bancel, Grenoble (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, PARIS (FR)

(21) Appl. No.: 11/987,783

(22) Filed: Dec. 4, 2007

(30) Foreign Application Priority Data
Dec. 21, 2006 (FR) 06 11184

(51) Int. Cl. H01M 4/38; H01M 6/00

(52) U.S. Cl. 429/218.1; 429/209; 427/58

(57) ABSTRACT

A lithium storage battery comprises a stack formed by a current collector comprising recessed zones, an electrode and a plurality of expansion cavities for the material forming the electrode. Each expansion cavity comprises at least one wall formed by a part of the electrode. Preferably the electrode is an electrode formed by at least one material able to insert and de-insert Li⁺ ions, the volume of which material increases when Li⁺ ions are inserted. The empty volume of the expansion cavities can thus be at least partially filled by a part of the material forming the electrode when Li⁺ cations are inserted in the material. The expansion cavities are formed in the recessed zones of the current collector.

### BACKGROUND OF THE INVENTION

The invention relates to a lithium storage battery comprising at least an electrolyte and a stack comprising an electrode, a current collector comprising a plurality of recessed zones delineated by side walls each comprising a free end, and expansion cavities for the electrode.

The invention also relates to a method for producing one such storage battery.

### STATE OF THE ART

Microbatteries in the form of thin films are based on the principle of insertion and de-insertion (or intercalation and de-intercalation) of an alkaline metal ion or of a proton in the positive electrode. The main known systems are lithium storage batteries using the Li⁺ cation as ionic species. The components of these lithium storage batteries (current collectors, positive and negative electrodes and electrolyte) are generally in the form of a stack of thin layers with a total thickness of about 15 μm. The stack is protected from the external environment, and specifically against humidity, by one or more superposed encapsulation layers, made for example from ceramic, polymer (hexamethyidisiloxane, parylene) and/or metal.

The thin layers of the lithium storage battery are generally obtained by physical vapor deposition (PVD) or by chemical vapor deposition (CVD). The use of such deposition techniques, which are standard practice in the microelectronics field, enable lithium storage batteries with any type of surface and shape to be achieved.

Depending on the materials used to form a lithium storage battery, the operating voltage of said battery is comprised between 1V and 5 V and the surface capacitances range from a few ten μAh/cm² to a few hundred μAh/cm².

The current collectors are generally made of metal, for example with a platinum, chromium, gold or titanium base.

The positive electrode is for its part formed by a material able to insert and de-insert the Li⁺ cation. It is for example formed by one of the following materials: LiCoO₂, LiNiO₂, LiMn₂O₄, CuS, CuS₂, WO_{y}S_{z}, TiO_{y}S_{z} and V₂O₅. Depending on the material chosen to form the positive electrode and in particular for lithiated oxides, thermal annealing can be performed after deposition of the thin layer to increase the crystallization of said layer and its Li⁺ cation insertion and de-insertion property.

The material forming the electrolyte has to be a good ionic conducting and electronic insulating material. The electrolyte materials most commonly used are phosphate-base materials such as LiPON and LiSiPON, for they present enhanced performances.

In a general manner, lithium storage batteries can be split into three families, depending on the nature of the negative electrode:

a) Li-Metal lithium storage batteries, for storage batteries comprising a negative electrode made of metallic lithium deposited by thermal evaporation or made of a lithium-base metal alloy.
b) Li-ion storage batteries, for storage batteries comprising a negative electrode formed by a Li⁺ cation insertion and de-insertion material such as SiTON, SnNₓ, InNₓ, SnO₂ . . . .
c) lithium storage batteries with no anode (also called Li-free storage batteries), for lithium storage batteries manufactured without a negative electrode. In this case, the negative electrode is formed in situ, during charging of the storage battery and due to the presence of a metallic layer blocking the lithium and arranged on the electrolyte. In this case, a metallic lithium deposit constituting the anode forms between the electrolyte and said metallic layer during charging of the storage battery.

These three families of lithium storage batteries do however each present shortcomings linked to the nature of their negative electrode.

Thus, the value of the melting point of lithium, which is 181° C., limits the temperature at which a Li-Metal type storage battery can be used. With such a storage battery, it is for example impossible to perform a solder re-flow process used to assemble integrated circuits. In addition, lithium presents a strong reactivity to air, which is penalizing for encapsulation, and it has to be deposited by thermal evaporation, which complicates the manufacturing process of the storage batteries.

In the case of Li-Ion storage batteries, the anode materials giving the best performances such as silicon lead to large volume expansions of up to 300%. These volume expansions do however generate large stresses on the electrolyte, which can lead to cracks and therefore to short-circuits making the battery unusable. Such phenomena can also occur in a Li-Free storage battery, as formation of lithium on the blocking metallic layer results in protuberances, also causing large stresses and potential breaking of the electrolyte.

More particularly, the problems of stresses in Li-ion storage batteries and Li-Free storage batteries lead to short-circuit rates of about 90% after 1,000 charging-discharging cycles, as underlined by U.S. Pat. No. 6,770,176 B2. To remedy this drawback, U.S. Pat. No. 6,770,176 B2 proposes to limit the diffusion of cracks that may tale place in the electrolyte by replacing the single electrolyte layer unique by a multilayer stack. The multilayer stack can comprise one or more intermediate layers made from Li⁺ ion conducting material, arranged between electrolytic layers for example made of vitreous LiPON or vitreous LiAlF₄. Such a solution is not however satisfactory, for it multiplies the number of layers to be deposited and the number of targets to be used for depositing the electrolyte. It therefore increases the cost of the production method. Moreover, the ionic conductivity of such a multilayer stack is lower than that of a single thin layer.

To prevent capacitance loss of Li-Ion storage batteries and to get round the difficulties of fabricating a metallic lithium anode, U.S. Pat. No. 6,168,884 proposes a particular Li-free storage battery. The storage battery thus comprises an anodic current collector that does not form intermetallic compounds with lithium and that is deposited between the electrolyte and an additional layer, for example made of LiPON, aluminium nitride or Parylene®. According to U.S. Pat. No. 6,168,884, it is disclosed that such a structure prevents formation of lithium that is usually of flocculent surface morphology and maintains a flat and smooth interface on the lithium anode. However this solution is not satisfactory, for, as indicated in U.S. Pat. No. 6,713,987, the thickness of the anode can be non uniform, which generates stresses and leads to short-circuits. Moreover, deposition of the additional layer increases the cost of the lithium storage battery and reduces the energy density factor of the storage battery.

To maintain the structural integrity of the Li-free storage battery, U.S. Pat. No. 6,713,987 for its part proposes that the anodic current collector of the Li-free storage battery be permeable to Li⁺ ions. During charging of the storage battery, the lithium then deposits on the external surface of the anodic current collector opposite the electrolyte. Such an arrangement does however require the storage battery to be fabricated in an encapsulation enclosure to protect the anode against the external environment. Producing the storage battery with its encapsulation enclosure is however complicated. Furthermore, such a storage battery occupies a large amount of space and can not be combined with an integrated circuit for example.

In the International application WO-A-2006/070158, the anode of a lithium microbattery is composed of silicon nanotubes or nanowires arranged on a current collector substrate. The anode thus comprises voids formed by the spacing between the different nanotubes or nanowires, voids which are designed to compensate the swelling inherent to discharging of the battery and to prevent stresses on the electrolyte. Fabrication of such an anode is however complex to implement. Several steps are in fact necessary for growth of the nanotubes or nanowires. In addition, this growth and in particular the height and perpendicularity of the nanotubes or nanowire with respect to the current collector substrate are not always well controlled.

In the International application WO-A-2005/076389, a Li-Ion storage battery with a liquid electrolyte uses an electrically conducting substrate comprising a plurality of cavities in which layers and in particular the anode are deposited. The anodic assembly formed by the patterned substrate and the anode and a cathodic assembly are then positioned vertically in an enclosure and a liquid or polymer gel electrolyte is arranged between the two assemblies. The electrolyte thus covers the whole of the anode contained in the cavities of the substrate. As the electrolyte is in liquid or polymer gel form, it follows the variations of the volume of the anode arranged in the cavities.

### OBJECT OF THE INVENTION

The object of the invention is to provide a lithium storage battery remedying the shortcomings of the prior art and in particular limiting the stresses exerted on the electrolyte while at the same time having high performances and being easy to implement.

According to the invention, this object is achieved by the appended claims.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 schematically represents a first embodiment of an assembly according to the invention in cross-section.

FIG. 2 schematically represents the current collector of the assembly according to FIG. 1 in partial cross-section along the line A-A.

FIGS. 3 to 6 schematically represent alternative embodiments of current collectors.

FIGS. 7 and 8 schematically represent, in cross-section, a lithium storage battery comprising the assembly according to FIG. 1, respectively when discharging and when charging.

FIG. 9 schematically represents an alternative embodiment of the assembly according to FIG. 1, in cross-section.

FIG. 10 schematically represents, in cross-section, a lithium storage battery comprising another alternative embodiment of FIG. 1.

FIG. 11 schematically represents, in cross-section, a second embodiment of an assembly according to the invention.

FIG. 12 schematically represents, in cross-section, an alternative embodiment of the assembly of FIG. 11.

FIG. 13 schematically represents, in cross-section, another embodiment of an assembly for a lithium stage battery.

FIG. 14 schematically represents, in cross-section an alternative embodiment of the assembly of FIG. 13.

### DESCRIPTION OF PARTICULAR EMBODIMENTS

A lithium storage battery (also called lithium battery), and more particularly a storage battery of Li-ion type in the form of thin layers, comprises at least an electrolyte formed by an electrolytic membrane in the form of a solid thin layer. The electrolytic membrane is arranged on an assembly for a lithium storage battery comprising a stack formed by a current collector and an electrode.

The electrode is an electrode formed by at least a material that is preferably able to insert and de-insert Li⁺ ions and having a volume which increases when Li⁺ ions are inserted. The electrode is advantageously a negative electrode formed by at least a material chosen for example from silicon, aluminium, germanium, tin and compounds thereof. For example, under certain cycling conditions, the volumic expansion of aluminium is 238%, that of silicon is 323% and that of tin is 358%.

The volumic variation of the electrode is compensated by the fact that the stack comprises expansion cavities for the electrode. Each expansion cavity comprises at least a wall formed by a part of the electrode. In this way, the empty volume of the expansion cavities can be at least partially filled by a part of the material forming the electrode when the Li⁺ cations are inserted in the electrode material. The cavity wall formed by a part of the electrode in fact enables the electrode material to expand in the volume of said cavity during insertion of the Li⁺ cations and the electrode material to be removed from said cavity during de-insertion of the Li⁺ cations.

More particularly, the expansion cavities for the electrode are formed in recessed zones arranged in the current collector. The recessed zones are delineated in the current collector by side walls each comprising a free end. The electrode arranged on the current collector comprises at least a continuous thin layer then covering the free end of said side walls so that the continuous thin layer of the electrode then forms at least one wall of each of the expansion cavities.

According to a first embodiment, the expansion cavities are formed by the recessed zones of the current collector and the continuous thin layer of the electrode is arranged on said current collector to cover said recessed zones.

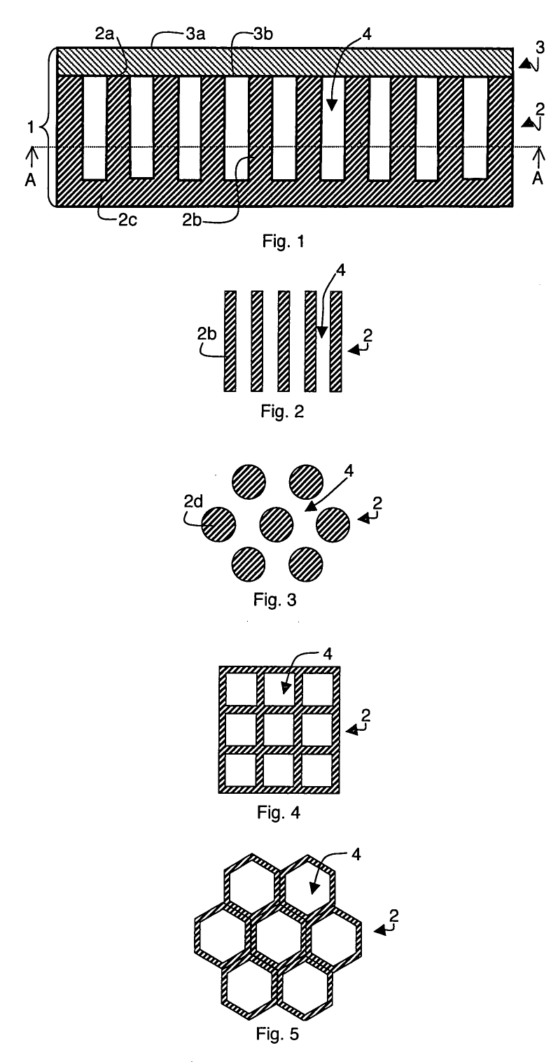

Thus, as represented in FIGS. 1 and 2, an assembly 1 for a lithium storage battery comprises a stack of two thin layers respectively forming current collector 2 and electrode 3. The electrode, formed by continuous thin layer 3, comprises flat and parallel opposite first and second surfaces 3a and 3b. First surface 3a is free and is designed to be in contact with the electrolytic membrane. Second surface 3b is in contact with surface 2a of current collector 2, in which the openings or recessed zones 4 constituting the expansion cavities are made. Second surface 3b of electrode 3 is thus arranged on the free ends of the side walls delineating the recessed zones in current collector 2.

Expansion cavities 4 are thus formed in current collector 2 and they extend up to surface 2a of current collector 2. The top wall of each expansion cavity 4 is formed by a predetermined zone of second surface 3b of electrode 3, arranged facing said cavity 4. The predetermined zone of second surface 3b corresponds more particularly to the zone arranged facing the corresponding cavity 4.

For example, current collector 2 is formed by a metal such as titanium, platinum, nickel or gold or by indium and tin oxide (ITO).

Formation of expansion cavities 4 in current collector 2 can be obtained by any type of known method and in particular by the methods conventionally used in the microelectronics field. More particularly, cavities 4 can be obtained by depositing a thin layer on a flat substrate by PVD, CVD, plasma enhanced chemical vapor deposition (PECVD) or by ink jet deposition, etc., and by photo-lithographing said thin layer by means of an etching mask from free surface 2a of the thin layer.

Expansion cavities 4 represented in FIGS. 1 and 2 are for example formed by patterning a thin layer in the form of a comb. More particularly, branches 2b are formed in said thin layer from surface 2a thereof. Branches 2b are preferably parallel to one another, perpendicular to surface 2a and of smaller height than the thickness of the thin layer so that they rest on a base 2c. Expansion cavities 4 thus correspond to the recessed zones created in the thin layer and separating branches 2b. Said branches 2b then form the side walls of expansion cavities 4 and the free zones of base 2c form the bottom walls which are advantageously parallel to the top walls formed by the zones of electrode 3.

For example, current collector 2 represented in FIGS. 1 and 2 can be formed from a thin layer of titanium with a thickness of 800 nm deposited by direct current cathode sputtering on a flat substrate. Expansion cavities 4 can then be created in the titanium thin layer forming by photolithography branches 2b of a height of about 600 nm and a width of 500 nm and separated from one another by a distance of 1000 nm. The space thus released between two adjacent branches 2b of current collector 2 forms an expansion cavity 4 for the material of electrode 4 when the Li⁺ cations are inserted in said electrode.

According to an alternative embodiment, the current collector could also be achieved by conformal deposition of the current collector on a substrate presenting a previously patterned surface. What is meant by conformal deposition of a thin layer is that the deposited layer has a constant thickness whatever the geometry of the surface on which it is deposited. Thus, in the case of a conformal deposition, the deposited layer will for example cover the recessed zones of a surface and the thickness of the layer will be constant over the whole of said surface. On the contrary, non-conformal deposition of a layer means that the material deposited on a surface comprising recessed zones with respect to a main plane does not enter into the recessed zones formed in said surface. The deposited layer then rests on the whole of the main plane of said surface, so that it comprises flat and parallel opposite surfaces.

Once the current collector has been formed, electrode 3 is formed on free surface 2a of current collector 2, by non-conformal deposition of a thin layer, for example by cathode sputtering.

Moreover, the geometric characteristics of the current collector are preferably chosen according to the expected volumic expansion for the electrode. Thus, the volume of the set of expansion cavities is preferably larger than or equal to the expansion volume provided for the electrode. The expansion volume provided for the electrode corresponds to the difference of volume occupied by the electrode respectively when Li⁺ cations are inserted in the material and when they are de-inserted. For a negative electrode, the expansion volume therefore corresponds to the difference of volume occupied by the electrode between a charging operation and a discharging operation. Electrode 3 represented in FIG. 1 is for example formed by a thin layer of silicon with a thickness of 100 nm deposited by radiofrequency (rf) cathode sputtering. Such a layer results in a capacitance of about 100 μAh/cm² with a volumic expansion of 300 nm/cm². For a lithium storage battery with a surface of 1 cm², the expansion volume of such an electrode 3 is about 3*10⁻⁵ cm³. For this example, the width of cavities 4 is equal to twice the width of branches 2b. The expansion cavities will thereby delineate a global volume at least equal to the expansion volume of the electrode.

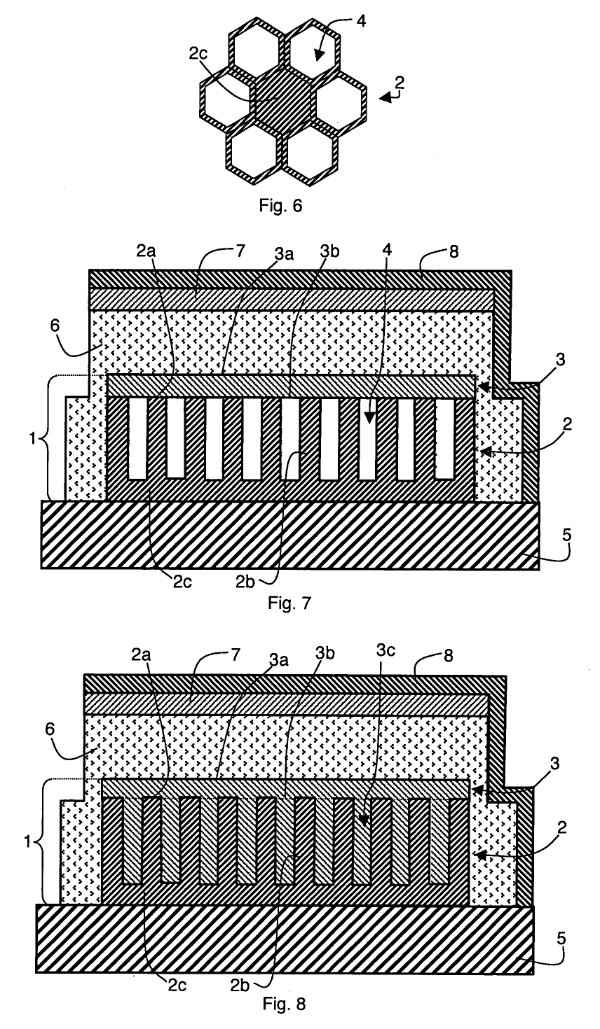

In FIGS. 1 and 2, expansion cavities 4 are of rectangular cross-section. However, they may be of any other shape. FIGS. 3 to 6 illustrate, for example purposes, alternative embodiments of current collector 2 represented in FIGS. 1 and 2. In FIG. 3, the current collector is patterned in the form of pads 2d of circular cross-section. In this case, expansion cavities 4 are not delineated by continuous side walls, unlike those represented in FIGS. 1 and 2. Expansion cavities 4 are delineated by the spaces between pads 2d and they communicate with one another to form a global expansion volume. Furthermore, the cross-section of pads 2d can be of any type, for example square, octagonal, etc. In FIG. 4, the patterning of current collector 2 enables a network of expansion cavities 4 of square cross-section to be formed, arranged in regular fashion in a matrix comprising a plurality of lines and a plurality of columns. In FIGS. 5 and 6, expansion cavities 4 are of hexagonal cross-section and they form a network of recesses commonly called a honeycomb. Seven adjacent cavities are represented in FIG. 5 whereas FIG. 6 represents six cavities 4 arranged uniformly around a central pillar 2e of hexagonal cross-section.

For illustration purposes, FIGS. 7 and 8 represent the use of stack 1 represented in FIGS. 1 and 2 as anodic stack in a lithium storage battery in the form of thin films, respectively when discharging and charging take place. Stack 1 is arranged on an upper insulating surface of a substrate 5. Substrate 5 is for example formed by a silicon support covered by one or more passivation layers for example made of SiO₂ and/or Si₃N₄ or by a ceramic or polymer layer. An electrolyte 6 formed by a solid electrolytic membrane, a positive electrode 7 and a positive current collector 8 are then successively deposited in the form of thin layers on stack 1 and the storage battery thus formed can be encapsulated (not shown). The materials used to form electrolyte 6, positive electrode 7 and positive current collector 8 can be of any known type. For example the electrolyte can be made of LiPON, the positive electrode can be made of LiCoO₂ and the positive current collector can be made of aluminium.

During fabrication of the storage battery or at the end of a discharging operation, expansion cavities 4 are empty whereas during a charging operation, i.e. during insertion of the Li⁺ cations in the material of negative electrode 3, the volume of the latter increases and the additional material will progressively occupy at least a part of des expansion cavities 4.

In FIG. 8, expansion cavities 4 are totally filled with the material of electrode 3. Electrode 3 is then composed of the initially deposited thin layer provided with a flat surface 3b in contact with the apex of branches 2b of current collector 2 and extended by a plurality of salient elements 3c substantially perpendicular to the plane of said surface 3b and housed in expansion cavities 4. In alternative embodiments, expansion cavities 4 can be only partly occupied by the electrode material at the end of a charging operation. The presence of the expansion cavities in the current collector-electrode assembly thereby enables said assembly to keep a constant external volume during implementation of the storage battery, which limits the stresses on electrolyte 6 and reduces the risks of short-circuits.

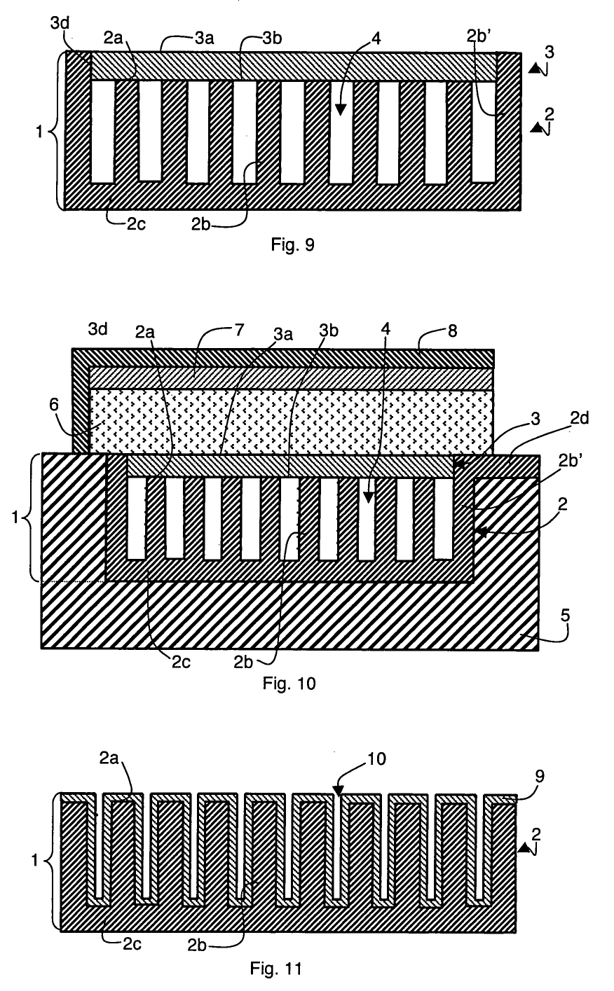

In the embodiment represented in FIG. 9, current collector 2 is also in the form of a comb. It does however comprise two external branches 2b′ forming external additional side walls, in current collector 2, of larger height than that of the other branches 2b of the current collector. In addition, the difference of height between branches 2b and external branches 2b′ corresponds substantially to the thickness of electrode 3. Finally, side walls or flanks 3d of electrode 3 are in direct contact with external branches 2b′, and the respective apexes of said external branches 2b′ are in the same plane as surface 3a of the electrode.

Such an embodiment enables the stresses caused on electrolyte 6 to be further limited, as it prevents walls 3d of electrode 3 from being in contact with the electrolyte. In this embodiment, only surface 3c of the electrode remains in contact with electrolyte 6. Moreover, the stresses exerted on the electrolyte can be further reduced by producing an electrolyte in the form of a thin layer of constant thickness comprising flat opposite surfaces, in particular the surface designed to be in contact with the electrode. To do this, and as represented in FIG. 10, an assembly 1 such as the one represented in FIG. 9 can be embedded in substrate 5. The substrate thereby comprises an opening of complementary shape to that of said assembly 1 to receive said assembly 1. Surface 3a of the electrode, the apex of external branches 2b′ and the free surface of substrate 5 are then in the same plane, and electrolyte 6 can be deposited in the form of a thin layer with a flat surface coming into contact with electrode 3, current collector 2 and substrate 5. As represented in FIG. 10, one of external branches 2b′ of current collector 2 is preferably extended at the end thereof by an element 2d. The element 2d is substantially perpendicular to the rest of said branch 2b′ and it's designed to come into contact with the free surface of substrate 5 to form an electric contact. In this case, substrate 5 is slightly etched over a depth equal to the thickness of element 2d to enable deposition of the electrolyte in the form of a step-free thin layer.

According to the invention, instead of being formed by the recessed zones of the current collector, the expansion cavities can also be delineated by the electrode.

Thus, according to a second embodiment represented in FIG. 11, assembly 1 can be formed by a current collector 2 comprising a surface 2a provided with a plurality of recessed zones and an electrode formed by a continuous thin layer 9 obtained by conformal deposition on said surface 2a of collector 2. The thin layer 9 is thus deposited on the whole surface 2a of the collector. It thereby covers the whole of the walls of the current collector delineating the recessed zones and the free ends of side walls 2b. Expansion cavities 10 are thus formed in the recessed zones of the current collector by the part of continuous thin layer 9 covering the walls of said zones. In this case, expansion cavities 10 are open, and do not comprise any upper walls. More particularly, the thickness of continuous thin layer 9 is selected such as to allow a free space between the two parts of thin layer 9 arranged facing a recessed zone, said space forming an expansion cavity.

In FIG. 11, the structure of current collector 2 is identical to that of the current collector represented in FIG. 1. It is in the form of a comb and the recessed zones are delineated by the spaces between branches 2b of current collector 2. The structure of current collector 2 is not limited to the embodiment represented in FIG. 11. The plurality of recessed zones can however form a network with any type of shape (honeycomb, square, parallelogram, etc).

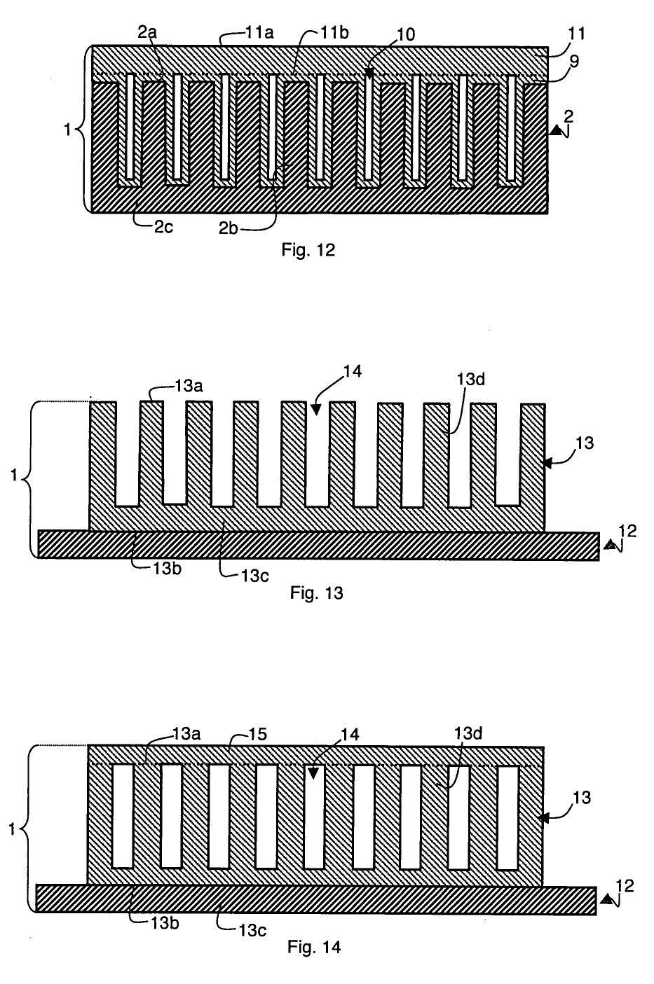

To improve the contact surface between the electrolyte and the electrode, as represented in FIG. 12, an additional thin layer 11 can be arranged on the continuous thin layer 9. The additional thin layer 11 is made of electrode material, with a constant thickness and comprising flat opposite surfaces 11a and 11b. The additional thin layer 11 thus enables closed expansion cavities 10 to be obtained arranged inside the electrode formed by the respectively conformal 9 and additional 11 thin layers. The zones of surface 11b of additional layer 11, arranged facing expansion cavities 10, do in fact form the top walls thereof. Additional layer 11 is formed by non-conformal deposition of an electrode material on thin layer 9 initially deposited by conformal deposition on surface 2a of the current collector. When non-conformal deposition is performed, the electrode material of additional layer 11 is therefore not inserted in the expansion cavities.

The electrode material of additional layer 11 can be identical to that deposited to form thin layer 9 by conformal deposition. For example, additional layer 11 is obtained by depositing silicon by PVD whereas thin layer 9 previously deposited on surface 2a of the current collector can be obtained by depositing silicon by CVD. However the respective materials of thin layers 9 and 11 may be different, for example to optimize the conformity of thin layer 9 and/or the interface between additional layer 11 and the electrolyte. For example, thin layer 9 is made of silicon and thin layer 11 is made of graphite or both layers 9 and 11 can be formed from the same material (for example SiₓGe_{y}) but with two different compositions (for example different values of x and y for the two SiₓGe_{y} compositions).

Another path for forming expansion cavities in the electrode-current collector assembly is represented in FIG. 13. The assembly 1 can comprise a current collector 12 which is for example flat, an electrode formed by a patterned thin layer 13 comprising first and second surfaces 13a and 13b. First surface 13a is free whereas second surface 13b is in contact with current collector 12. In addition, the electrode comprises a plurality of recessed zones 14 patterning said thin layer 13 and extending up to second surface 13b. Said recessed zones 14 form expansion cavities for the electrode material. As in the case of a patterned current collector, the geometric characteristics of patterned thin layer 13 forming the electrode are preferably chosen according to the expected volumic expansion for the electrode material. The expansion cavities can thus have any type of shape. In FIG. 13, thin layer 13 is patterned in the form of a comb so that it comprises a substantially flat base 13c extended vertically by branches 13d. Branches 13d delineate the side walls of expansion cavities 14 whereas the free zones of base 13c delineate the bottom walls thereof. Such an embodiment is more particularly suitable in the case where patterned thin layer 13 presents electronic conductivity properties and in the case where it can be easily patterned. It thus partially replaces the current collector. Patterned thin layer 13 can be obtained by formation by carbon nanotubes or by formation of a thin layer of strongly doped photo-lithographed silicon or germanium or by growth of nanowires.

In the embodiment represented in FIG. 13, cavities 14 are open. On the other hand, as represented in FIG. 14, expansion cavities 14 can be closed by performing a non-conformal deposition, on first surface 13a, of an additional layer 15 of electrode material identical to or different from the material forming patterned thin layer 13. Depositing additional layer 15 in non-conformal manner enables the material of said layer not to fill expansion cavities 14. The material or materials of layers 13 and 15 are preferably materials able to insert and de-insert Li⁺ ions and having a volume which increases when Li⁺ ions are inserted.

An assembly according to one of the above embodiments presents the advantage of being able to keep a constant external volume, which reduces the stresses exerted on the electrolyte of a lithium storage battery in the form of thin films and reduces the risks of short-circuits. In addition, the assembly is easy to implement, the techniques used being techniques compatible with the industrial processes used in the microelectronics field. This facilitates integration of lithium storage batteries comprising such an assembly to supply the necessary energy for electronic Microsystems or microcomponents such as chip cards, smart tags, internal clocks, etc. These applications in fact require all the thin layers necessary for operation of the lithium storage battery to be produced with techniques compatible with industrial microelectronics processes.

The invention is not limited to the embodiments described above. More particularly, the electrode can be a positive electrode if the volume of material of said electrode increases when Li⁺ cations are inserted.

We claim:

1. A lithium storage battery comprising at least an electrolyte and a stack comprising:
an electrode,
a current collector comprising a plurality of recessed zones delineated by side walls each comprising a free end,
and expansion cavities for the electrode,
wherein:
the electrode comprises at least a continuous thin layer covering the free end of the side walls of the current collector,
the electrolyte is formed by an electrolytic membrane in the form of a solid thin layer deposited on said stack,
each expansion cavity is formed in a recessed zone and comprises at least a wall formed by the continuous thin layer of the electrode.

2. The storage battery according to claim 1, wherein the continuous thin layer forming the electrode comprises opposite first and second flat and parallel surfaces respectively in contact with the electrolytic membrane and the free ends of the side walls of the current collector.

3. The storage battery according to claim 2, wherein the current collector comprises external additional side walls having a larger height than that of the side walls, the difference in height between the side walls and the external additional side walls being substantially equal to thickness of the continuous thin layer.

4. The storage battery according to claim 3, wherein the continuous thin layer comprises flanks in contact with the external additional side walls.

5. The storage battery according to claim 1, wherein the whole of the side walls of the current collector is covered by the continuous thin layer.

6. The storage battery according to claim 5, wherein the electrode comprises an additional thin layer comprising flat and parallel opposite surfaces and arranged on the continuous thin layer, one of the surfaces of the additional thin layer delineating the expansion cavities with the continuous thin layer.

7. The storage battery according to claim 1, wherein the electrode is a negative electrode.

8. The storage battery according to claim 1, wherein the electrode is formed by a material able to insert and de-insert Li⁺ cations and presenting a volumic expansion when insertion of Li⁺ cations is performed.

9. The storage battery according to claim 8, wherein said material is selected from the group consisting of silicon, aluminium, germanium, tin and compounds thereof.

10. The storage battery according to claim 1, wherein the current collector is formed by a patterned thin layer in the form of a comb or in the form of pads of circular, square or octagonal cross-section.

11. The storage battery according to claim 1, wherein the expansion cavities are of rectangular or hexagonal cross-section.

12. The storage battery according to claim 11, wherein the expansion cavities being of hexagonal cross-section, they form a honeycombed network of recesses.

13. A method for producing a lithium storage battery according to claim 1, comprising the following successive steps:
a) formation of a current collector comprising a plurality of recessed zones delineated by side walls each comprising a free end,
b) formation of an electrode comprising at least a continuous thin layer covering the free end of the side walls of the current collector, and formation of expansion cavities for the electrode, each being formed in a recessed zone and comprising at least a wall formed by the continuous thin layer of the electrode
c) and formation of an electrolyte formed by an electrolytic membrane in the form of a solid thin layer deposited on said stack.

14. The method according to claim 13, wherein step b) comprises formation by non-conformal deposition of the continuous thin layer forming the electrode on the free end of the side walls of the current collector.

15. The method according to claim 14, wherein step b) comprises formation by conformal deposition of the continuous thin layer on the whole of the side walls of the current collector and of the free ends of said walls.

16. The method according to claim 15, wherein formation of the continuous thin layer is followed by non-conformal deposition of an additional thin layer on said continuous thin layer.
